(19) United States
(12) Patent Application Publication
(10) Pub. No.: US 2023/0342599 A1
(43) Pub. Date: Oct. 26, 2023

(54) ACCELERATING DISTRIBUTED MACHINE LEARNING WITH SMART NICS

(71) Applicant: VMware, Inc., Palo Alto, CA (US)

(72) Inventors: Shay Vargaftik, Herzliya (IL); Yaniv Ben-Itzhak, Afek (IL); Alex Markuze, Ramat Gan (IL); Igor Golikov, Kfar Saba (IL); Avishay Yanai, Petach-Tikva (IL)

(21) Appl. No.: 17/727,172

(22) Filed: Apr. 22, 2022

(51) Int. Cl. G06N 3/08; G06N 3/04

(52) U.S. Cl. CPC G06N 3/08; G06N 3/0454

(57) ABSTRACT

Some embodiments provide a method for performing distributed machine learning (ML) across multiple computers. At a smart network interface controller (NIC) of a first computer, the method receives a set of ML parameters from the first computer related to training an ML model. The method compresses the set of ML parameters based on a current state of a connection to a central computer that receives sets of ML parameters from a plurality of the computers. The method sends the compressed set of ML parameters to the central computer for the central computer to process the compressed set of ML parameters along with corresponding sets of ML parameters received from the other computers of the plurality of computers.

### BACKGROUND

Especially in the datacenter context, programmable smart network interface controllers (NICs) are becoming more commonplace. These smart NICs typically include a central processing unit (CPU), possibly in addition to one or more application-specific integrated circuits (ASICs) or field-programmable gate arrays (FPGAs). These ASICs (or FPGAs) can be designed for packet processing as well as other uses. However, the inclusion of the CPU also allows for more configurability of the smart NICs, thereby enabling the offloading of some tasks from software of a host computer.

### BRIEF SUMMARY

Some embodiments provide a method for using smart network interface controllers (NICs) to perform distributed machine learning (MIL). The smart NICs of a group of computers are configured to perform a subset of the ML tasks that are distributed across the group of computers without requiring involvement from the software of these computers for some of these tasks. Specifically, in some embodiments the smart NICs at the group of computers handle compression of training-related parameters that are sent to a parameter server, while the smart NIC(s) at the parameter server decompresses these parameters received from the various computers, evaluates a function of the parameters to generate a global parameter, and provides this global parameter to the computers of the group.

In some embodiments, the smart NICs at the group of computers compress the parameters based on the current state of their respective connections to the parameter server (e.g., to the smart NIC at the parameter server). When a connection between a smart NIC at one of the computers and the parameter server becomes more congested, the smart NIC can increase the level of compression used to send parameters to the parameter server. Similarly, as the connection improves, the smart NIC can decrease the level of compression used. For instance, the smart NIC may adjust the level of compression based on receipt of congestion control messages from the network. Because the smart NIC is closer to the network than the software networking components of the computer, the smart NIC is in a better position to make these decisions about the level of compression and can implement the changes more quickly (in addition to being able to perform the compression more quickly).

The type of compression used can vary in different embodiments. For instance, some embodiments quantize the parameters to different numbers of bits depending on the network connection state. A 32-bit parameter, for example, could be quantized to 8 bits if the network connection is not congested but quantized to 4 bits (or even less) if the network connection is more congested. Other types of compression that are used in some embodiments include elimination of certain parameters that are smaller than a threshold value (sparsification) or projection of multi-dimensional parameters to a lower number of dimensions (e.g., using transformation, rotation, sketching, etc.). Some embodiments use compression techniques that rely on shared random numbers, so as long as the smart NIC at the computer and the smart NIC at the parameter server are given the same seed value.

In some embodiments, the ML parameters compressed by the smart NICs at the various computers are local gradients computed at these computers, which are sent to the parameter server for the parameter server to compute a global gradient. In some embodiments, each of the respective computers in the group of computers trains its own respective copy of the ML model (e.g., by forward propagating a respective set of inputs through the ML model and then performing back-propagation to identify updates to the ML model based on that training, with this process repeated over numerous iterations). In some embodiments, only a subset of the computers performs this training for a given training iteration (e.g., a randomly chosen subset). Each iteration of the training results in gradients specifying how each of the various trainable parameters of the ML model (e.g., weights, biases, etc. for a neural network) should be updated. Each of the respective computers sends the local gradients for a given parameter to the parameter server, which computes a function (e.g., an average) from these local gradients to generate a global gradient for updating the parameter. The global gradients are then provided back to the individual computers that perform the ML model training so that the copies of the model will be updated in the same way at each of these computers before the next training iteration (e.g., to all of the computers, not just those that participated in that particular training iteration).

The smart NICs at each of the computers compress the local gradients (e.g., based on the network state as well as, potentially, other metadata) and send these compressed local gradients to the parameter server through the network. In some embodiments, the smart NICs may schedule the sending of the compressed gradients to the parameter server out of order based on various factors (e.g., ensuring that training can continue with minimal delay). In some embodiments, a smart NIC at the parameter server is configured to decompress these local gradients and compute the global gradients (or, in some cases, perform at least part of the global gradient calculation prior to decompression). In some embodiments, the parameter server smart NIC then compresses the global gradients and sends the global gradients to the various computers performing the ML training (so that the software at the parameter server does not need to be involved in the gradient updates). The individual computer smart NICs can then decompress these global gradients and provide the global gradients to the ML training software on their respective computers so that the ML models can be updated and the next training iteration performed. In other embodiments, the global gradients are not compressed when sent to the various training computers (e.g., to ensure the actual update to the ML model uses the most accurate version of the gradients).

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a distributed ML training system of some embodiments.

FIG. 2 conceptually illustrates the hardware of a smart NIC of some embodiments that can be configured to participate in compression, transfer, calculation, and/or decompression of parameters for a distributed ML system.

FIG. 3 conceptually illustrates the NIC OS of a smart NIC of some embodiments.

FIG. 4 conceptually illustrates a process of some embodiments for sending local parameters (e.g., local gradients) to a parameter server.

FIG. 5 conceptually illustrates the smart NIC gradient scheduling of some embodiments.

FIG. 6 conceptually illustrates the quantization of gradients by a smart NIC based on network state for two different training runs, over three stages.

FIG. 7 conceptually illustrates a process of some embodiments for handling sets of local parameters from a set of distributed training machines and providing global parameters to these training machines.

FIG. 8 conceptually illustrates a process of some embodiments for providing global parameters to a training machine.

FIG. 9 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method for using smart network interface controllers (NICs) to perform distributed machine learning (ML). The smart NICs of a group of computers are configured to perform a subset of the ML tasks that are distributed across the group of computers without requiring involvement from the software of these computers for some of these tasks. Specifically, in some embodiments the smart NICs at the group of computers handle compression of training-related parameters that are sent to a parameter server, while the smart NIC(s) at the parameter server decompresses these parameters received from the various computers, evaluates a function of the parameters to generate a global parameter, and provides this global parameter to the computers of the group.

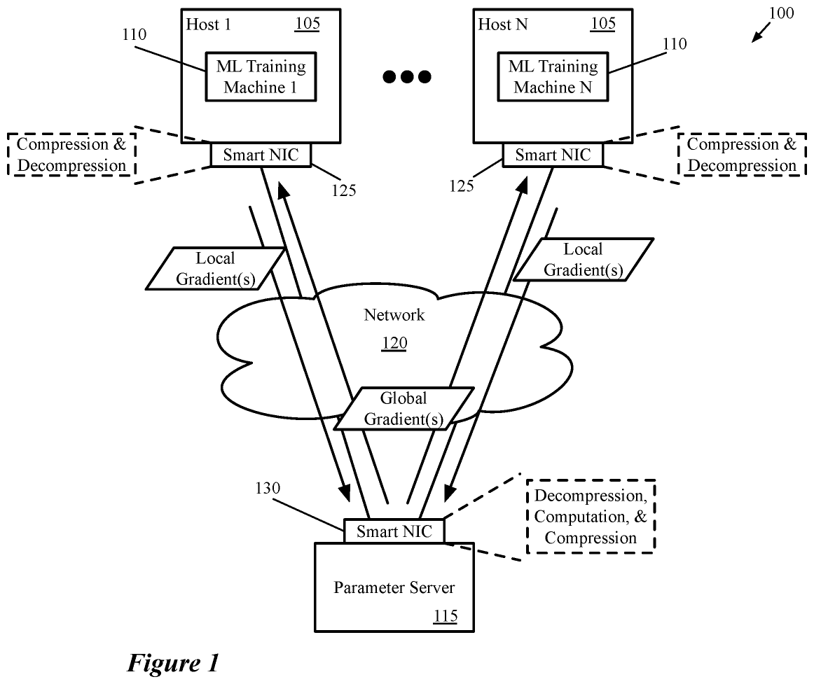

FIG. 1 conceptually illustrates a distributed ML training system 100 of some embodiments. As shown, the training system includes a set of N host computers 105 on which N training machines 110 execute for training an ML model (e.g., a neural network, a random forest model, a boosting model, etc.). Each of the machines 110, in some embodiments, trains the same model using different sets of inputs for each iteration. By distributing the training, the processing power of multiple machines can be used to accelerate the training, as opposed to relying on a single machine to perform all of the (very extensive, in many cases) calculations required. In different embodiments, these machines 110 may be virtual machines (VMs), containers, or other types of virtualized data compute nodes (DCNs). In other embodiments, the training operations are executed directly within the operating system of bare metal host computers 105 (i.e., without any compute virtualization). It should also be noted that although each of the training machines 110 are shown as operating on a different host computer 105, in some embodiments at least some of the host computers may execute multiple training machines. In addition, while the figure shows a single model being trained on the host computers 105, in some embodiments each host computer (or a subset of the host computers) may execute training machines for multiple different ML models (i.e., with multiple different ML models being trained by the training system, either for different tasks or all for the same task).

The training system 100 also includes a parameter server 115 to which the host computers 105 connect through a network 120. This parameter server 115 may also be implemented as a VM, container, bare metal computing device, etc., in different embodiments. The parameter server 115, in some embodiments, helps coordinate the distributed ML training. Specifically, each of the ML training machines 110 computes various local training parameters (e.g., gradients for ML model parameters) and sends the local training parameters to the parameter server 115. The parameter server 115 is then responsible for generating a global parameter for each set of local parameters and returning this global parameter to the training machines 110. The training machines 110 use the global parameters to update the ML model so that they can execute the next training iteration (or arrive at a final model after the last iteration).

In some embodiments, the parameters compressed by the smart NICs at the various computers are local gradients computed at these computers, as shown in the figure. For instance, to train a neural network, in some embodiments each of the training machines 110 uses the same neural network (i.e., with the same weights, biases, and other parameters). Each training machine 110 forward propagates a different set of training inputs through the network and then performs backpropagation to compute local gradients for modifying each of the trainable parameters of the network. In some embodiments, only a subset of the training machines perform this forward propagation and backpropagation of errors at each iteration (e.g., a randomly-selected subset for each iteration) to compute the local gradients. These local gradients specify how each of the various trainable parameters of the neural network should be updated based on the results output by the neural network for the locally-used training inputs. Many neural networks can include hundreds of millions of trainable parameters, such that each training machine 110 computes hundreds of millions of local gradients.

The training machines 110 send these local gradients to the parameter server 115, and for each parameter, the parameter server 115 computes a global gradient (e.g., by averaging the local gradients). The global gradients are then sent back to the training machines 110, which use them to update their respective copies of the neural network. When only a subset of the training machines compute local gradients during a particular iteration, some embodiments send the global gradients back to all of the training machines (including those that did not participate in the particular training iteration). Because the same global gradients are used for the update, all of the copies of the neural network are updated in the same way such that they remain the same across all of the training machines 110. It should be understood that while the example of a neural network is described here, the invention described also applies to the training of other ML models with different types of parameters.

As shown in the figure, each of the host computers 105 includes a smart NIC 125 and the parameter server 115 includes its own smart NIC 130. Each of these smart NICs 125, as described in more detail below, is a configurable network interface controller that includes a (typically low-power) general-purpose CPU in addition to one or more purpose-specific circuits (e.g., data message processing circuits). In some embodiments, the smart NICs 125 at the host computers 105 are configured to perform a subset of the ML tasks that would otherwise be performed by the training machines 110. Similarly, the smart NIC 130 is configured to perform a subset of the parameter server tasks.

Specifically, in some embodiments, the smart NICs 125 compress local gradients (or other locally computed parameters) computed by the training machines 110, schedule the sending of these compressed local gradients, and send them to the parameter server 115 via the network 120. The smart NIC 130 at the parameter server, in some embodiments, decompresses these local gradients and computes a global gradient for each local gradient once the local gradients are received from all of the training machines 110. In some embodiments, the smart NIC 130 passes some of the decompressed local gradients to the parameter server 115 for the parameter server to perform the necessary global gradient computations if the smart NIC 130 is not capable of performing these computations.

The smart NIC also compresses the global gradients, schedules the sending of the compressed global gradients, and sends them to the training machines 110. The smart NICs 125 at the hosts 105 then decompress the global gradients received from the parameter server 115 and provide the global parameters to the training machines 110 so that the training machines can update their models. In some embodiments, the global gradients are not compressed by the smart NIC at the parameter server and are instead sent uncompressed so that the copies of the neural network can be updated using the most exact gradient data. More generally, in different embodiments, compression may be used by the smart NICs for the local gradients sent to the parameter server and/or for the global gradients returned to the training machines.

In some embodiments, the smart NICs 125 at the hosts 105 compress the local gradients based on the current state of their respective connections to the parameter server 115 (e.g., to the smart NIC 130 at the parameter server). When the connection between a particular smart NIC 125 at one of the computers and the parameter server 115 becomes more congested (or if the network 120 is generally more congested), the smart NIC 125 increases the level of compression used to send the local gradients to the parameter server 115. Similarly, as the connection improves, the smart NIC 125 decreases the level of compression used. For instance, the smart NIC 125 may adjust the level of compression based on receipt of congestion control messages from the network. Because the smart NICs 125 are closer to the network than the training machines 110 or the networking software of the host computers 105, the smart NICs 125 are in a better position to make decisions about the appropriate level of compression and can implement the changes more quickly (in addition to being able to perform the compression more quickly). It should also be noted that the smart NICs 125 may consider other factors (e.g., network transfer cost, current training status, etc.) in determining the level of compression to be used.

The type of compression used by the smart NICs 125 can vary in different embodiments. For instance, in some embodiments the smart NICs 125 quantize the gradients to different numbers of bits depending on the network connection state. A 32-bit gradient, for example, could be quantized to 8 bits if the network connection is not congested but quantized to 4 bits (or even less) if the network connection is more congested. Other types of compression that are used in some embodiments include elimination of certain parameters that are smaller than a threshold value (sparsification) or projection of multi-dimensional parameters to a lower number of dimensions (e.g., using transformation, rotation, sketching, etc.). Some embodiments use compression techniques that rely on shared random numbers, so as long as the smart NICs 125 at the host computers and the smart NIC 130 at the parameter server are provided with the same seed value.

Along similar lines, the smart NIC 130 at the parameter server 115 also evaluates the state of its network connections to determine how to compress the global gradients in some embodiments. In some such embodiments, however, the global gradients are only compressed once, so different connections to different training machines 110 are not evaluated separately to determine different levels of compression. In addition, other embodiments use a consistent level of compression for the global gradients. It should also be noted that the smart NIC 130 may consider other factors (e.g., network transfer cost, current training status, etc.) in determining the level of compression to be used.

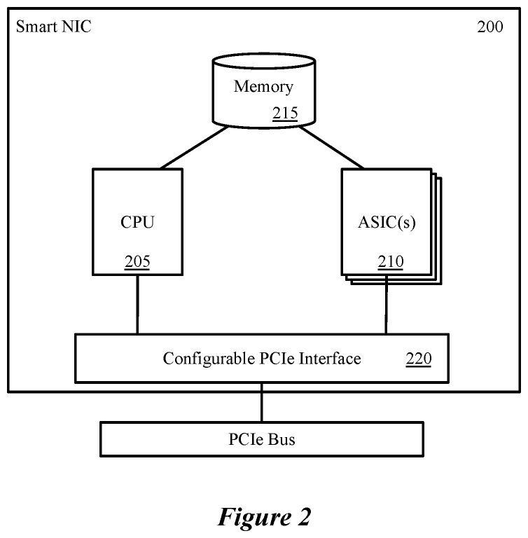

As mentioned above, the smart NICs of some embodiments include both a general-purpose processor (typically less powerful than the processor of the computer for which the smart NIC acts as the network interface) as well as one or more application-specific circuits. FIG. 2 conceptually illustrates the hardware of a smart NIC 200 of some embodiments that can be configured to participate in compression, transfer, calculation, and/or decompression of parameters for a distributed ML system. As shown, the smart NIC 200 includes its own general-purpose (x86) CPU 205, a set of application-specific integrated circuit (ASICs) 210, memory 215, and a configurable PCIe interface 220. The ASICs 210, in some embodiments, include at least one I/O ASIC that handles the processing of data messages forwarded to and from the computer, and are at least partly controlled by the CPU 205. In some embodiments, either in addition to or as an alternative to the ASICs, the smart NIC may include a set of configurable field-programmable gate arrays (FPGAs).

The configurable PCIe interface 220 enables connection of the smart NIC 200 to the other physical components of a computer system (e.g., the x86 CPU, memory, etc.) via the PCIe bus of the computer system. Via this configurable PCIe interface, the smart NIC 200 can present itself to the computer system as a multitude of devices, including a data message processing NIC, a hard disk (using non-volatile memory express (NVMe) over PCIe), or other types of devices. The CPU 205 executes a NIC operating system (OS) in some embodiments that controls the ASICs 210 and can perform other operations, such as compression of ML parameters, dynamic scheduling of the sending of these parameters, decompression of the parameters, and/or global parameter computations based on the local parameters.

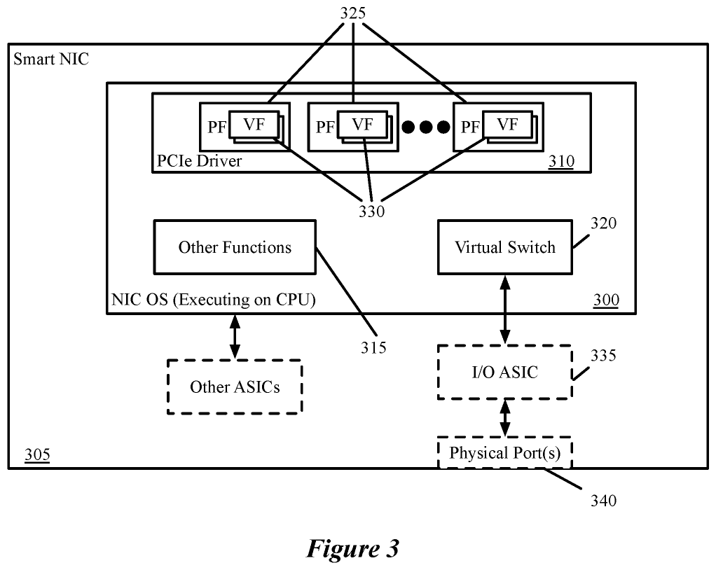

FIG. 3 conceptually illustrates the NIC OS 300 of a smart NIC 305 of some embodiments. The NIC OS 300 is executed, in some embodiments, by the CPU of the smart NIC (e.g., CPU 205). This NIC OS 300 includes a PCIe driver 310, a virtual switch 320, and other functions 315.

The PCIe driver 310 includes multiple physical functions 325, each of which is capable of instantiating multiple virtual functions 330. These different physical functions 325 enable the smart NIC to present as multiple different types of devices to the computer system to which it attaches via its PCIe bus. For instance, the smart NIC can present itself as a network adapter (for processing data messages to and from the computer system) as well as a non-volatile memory express (NVMe) disk in some embodiments.

The NIC OS 300 of some embodiments is capable of executing a virtualization program (similar to a hypervisor) that enables sharing resources (e.g., memory, CPU resources) of the smart NIC among multiple machines (e.g., VMs) if those VMs execute on the computer. The virtualization program can provide compute virtualization services and/or network virtualization services similar to a managed hypervisor in some embodiments. These network virtualization services, in some embodiments, include segregating data messages into different private (e.g., overlay) networks that are defined over the physical network (shared between the private networks), forwarding the data messages for these private networks (e.g., performing switching and/or routing operations), and/or performing middlebox services for the private networks.

To implement these network virtualization services, the NIC OS 300 of some embodiments executes the virtual switch 320. The virtual switch 320 enables the smart NIC to perform software-defined networking and provide the I/O ASIC 335 of the smart NIC 305 with a set of flow entries so that the I/O ASIC 335 can perform flow processing offload (FPO) for the computer system in some embodiments. The I/O ASIC 335, in some embodiments, receives data messages from the network and transmits data messages to the network via one or more physical network ports 340.

The other functions 315 executed by the NIC operating system 300 of some embodiments can include various other operations, including the operations described regarding the local and global parameters, depending on where in the ML training system the smart NIC is located. That is, these other functions 315 can include compression of ML parameters, dynamic scheduling of the sending of these parameters, decompression of parameters, and/or global parameter computations based on the local parameters.

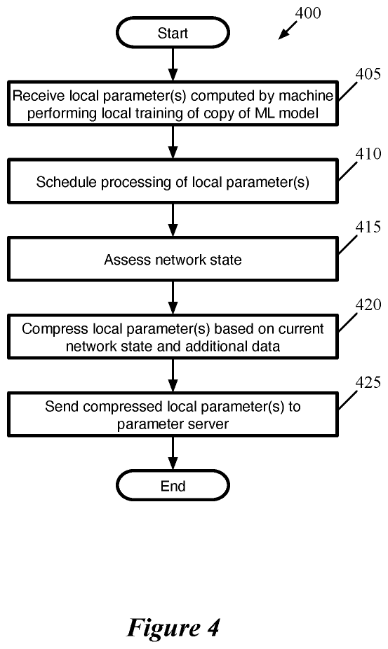

FIG. 4 conceptually illustrates a process 400 of some embodiments for sending local parameters (e.g., local gradients) to a parameter server. In some embodiments, the process 400 is performed by a smart NIC located at a host computer on which one training machine instance of a distributed training system for one or more ML models executes (e.g., one of the smart NICs 125 of FIG. 1. The process 400 is described being performed for a set of parameters that are processed together (e.g., the local gradients for a single layer of a neural network). It should be understood that the process 400 is performed by the smart NICs of some embodiments for many such sets of parameters both sequentially and in parallel. That is, the smart NIC might not complete the processing of local gradients for a first layer of a first neural network being trained on its host computer before receiving (and potentially beginning the processing of) local gradients for a second layer of the first neural network and/or a layer of a second neural network. The scheduling of the processing of parameters in such cases will be described in conjunction with the process.

As shown, the process 400 begins by receiving (at 405) local parameters computed by a machine performing local training of a copy (instance) of an ML model for a distributed training system. As described above, in some embodiments these parameters are the gradients computed for a set of neural network weights after forward propagating a set of inputs through the neural network and backpropagating a loss calculated based on the outputs generated by the network. In some embodiments, the smart NIC receives the local gradients for a single neural network layer as a set to be processed together. Each layer can include many thousands or even multiple millions of trainable parameters (e.g., weights, biases, etc.), each of which has its own local gradient computed during each training iteration. In some embodiments, the local gradients for a single neural network layer are received as an array of values, with each value representing the gradient for a different trainable parameter in the layer. When processing a batch of inputs through the network, the training machine in some embodiments processes all of the inputs through one layer at a time, then performs backpropagation through the layers in the reverse order. When the local gradients for a layer are computed, the training machine sends these to the parameter server for the training system via the smart NIC.

The process 400 then schedules (at 410) the processing of the local parameters. In some embodiments, if the load is not too high, the smart NIC processes each set of parameters in the order they are received. However, some embodiments also allow for various types of dynamic scheduling. As noted, in some embodiments the smart NIC receives the gradients for the parameters of a single neural network layer as a set to be processed. Because backpropagation begins at the last neural network layer, the gradients for this layer are received first for a given training iteration. However, if the backpropagation and gradient calculation is faster than the processing required for the smart NIC to compress and send the gradients for a layer, then one or more layers of gradients will be received at the smart NIC prior to the completion of this last layer, eventually causing a bottleneck at the smart NIC (which would typically be worse if being performed by the host computer CPU). In order for the training machine to begin processing the next training iteration, that machine needs to update the trainable parameters of its local model using the global gradients, starting at the first network layer. Thus, it may not be efficient to send the local gradients for the first layer to the parameter server last, even though this is the last set of gradients sent to the smart NIC for the previous training iteration. In this case, the smart NIC can dynamically schedule the local gradients for earlier network layers ahead of those for later layers, despite the gradients for the later layers being received at the smart NIC earlier. Specifically, in some embodiments, the smart NIC schedules the gradients for the earliest network layer that it has received as the next set of gradients for processing.

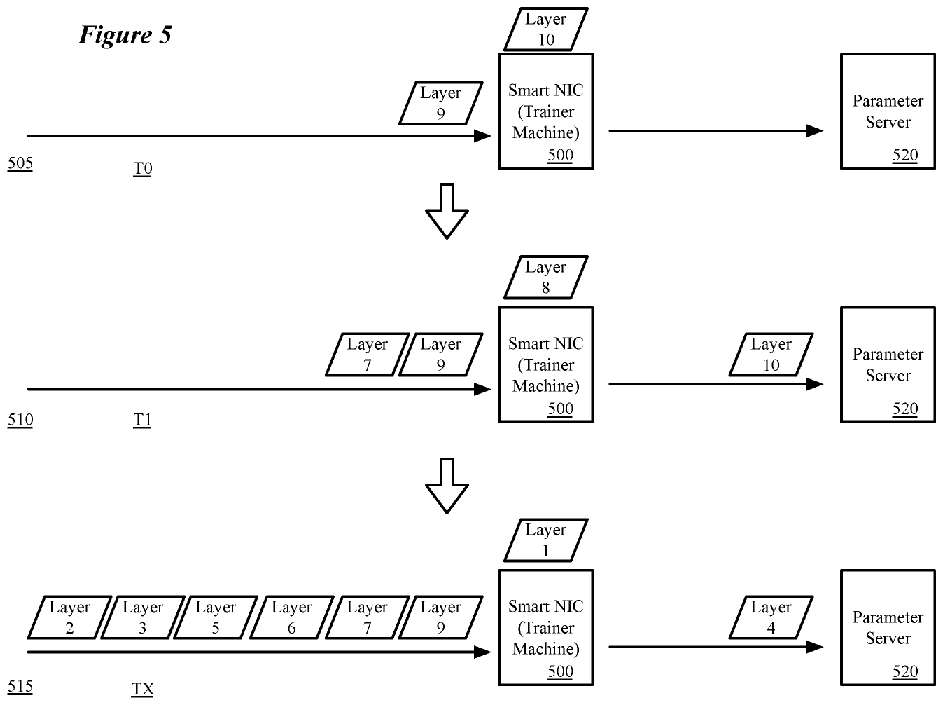

FIG. 5 conceptually illustrates the smart NIC gradient scheduling of some embodiments over three stages 505-515. In this example, a smart NIC 500 at a host computer implementing a trainer machine receives sets of gradients from the trainer machine (not shown) and sends them to a parameter server 520 (e.g., through a network to a smart NIC at the parameter server). In the first stage 505, at a first time TO, the smart NIC 500 has received and begun processing the gradients for layer 10 (the last layer of a 10-layer neural network). In addition, the smart NIC 500 has received the gradients for layer 9 but has not begun processing these gradients yet, as they remain enqueued.

In the second stage 510, at time T1, the smart NIC 500 has sent the layer 10 gradients to the parameter server 520. However, because the smart NIC 500 received the layer 8 gradients prior to completing processing of the layer 10 gradients, the smart NIC 500 begins processing of these layer 8 gradients, leaving the layer 9 gradients enqueued (because the layer 8 gradients are earlier in the neural network than the layer 9 gradients). The layer 7 gradients are also enqueued at this time, having been sent to the smart NIC 500 after processing began for the layer 8 gradients.

In the third stage 515, at time TX, the smart NIC 500 has most recently sent the layer 4 gradients to the parameter server 520 and begun processing the layer 1 gradients (which were received prior to completing processing of the layer 4 gradients). At this point, the layer 1 gradients should be processed first because receiving the global gradients for the first layer will allow the training system to begin updating its local copy of the neural network and processing the next batch of inputs through the network. From this point, the gradient sets are scheduled in order by layer (i.e., layer 2, then layer 3, then layer 5, etc.).

In addition to the case of scheduling layers for a single neural network out of order, some embodiments also dynamically schedule sets of parameters for multiple models. If training machines for multiple different ML models (multiple neural networks, multiple different types of models, etc.) execute on the same host in a training system, then the smart NIC may receive a set of gradients for one model (e.g., gradients for one layer of a first neural network) in between sets of gradients for a different model (e.g., gradients for two layers of a second neural network). In some embodiments, the smart NIC is preconfigured to give priority to specific models or specific layers of a model. In other embodiments, the smart NIC is configured to dynamically schedule sending the gradients (or other parameters) of the various different models based on various factors. For instance, different embodiments may give preference to gradients for a particular model or particular layers, alternate between models, or allow the training machines for models to send a notification to the smart NIC when they are waiting for specific global gradients so that the corresponding local gradients can be moved up in the queue.

Returning to FIG. 4, the process 400 assesses (at 415) the network state. In some embodiments, the network state is assessed by the smart NIC for each set of local parameters that are compressed and sent as a group (e.g., the gradients for each neural network layer). In other embodiments, the smart NIC assesses the network state once for a given training iteration and makes processing (e.g., parameter compression) decisions based on that state. The network state assessment, in different embodiments, may account for congestion of the network as a whole or specifically the connection to the parameter server. In some embodiments, the smart NIC keeps statistics on the amount of data sent and received and uses these statistics to determine whether the network is overloaded. Alternatively, or additionally, in some embodiments the smart NIC uses congestion control messages from the parameter server or from network elements along the path to the parameter server to determine the network state.

Next, the process 400 compresses (at 420) the local parameters based on the current network state and, in some cases, additional data. The process 400 then sends (at 425) the compressed local parameters to the parameter server, then ends. In general, as the network connection to the parameter server (or the network generally) becomes more congested, the smart NIC increases the level of compression applied to the local parameters. That is, as network congestion increases, the smart NIC compresses a given amount of local parameter data into a smaller amount of compressed data to send to the parameter server. Because the smart NIC is closer to the network than the software networking components (or other components that could perform compression) of its host computer, the smart NIC is in a better position to make these decisions about the level of compression and can implement the changes more quickly.

The type of compression used can vary in different embodiments. For instance, some embodiments quantize the parameters to different numbers of bits depending on the network connection state. A 32-bit parameter, for example, could be quantized to 8 bits if the network connection is not congested but quantized to 4 bits (or even less) if the network connection is more congested. Some embodiments are able to compress gradients down to less than one bit per gradient value. It should also be noted that some embodiments may use other factors to determine the extent to which the gradients should be compressed. In some embodiments, the training machines can exchange control messages with each other and/or with the parameter server to signal how the gradients should be compressed. For instance, if all of the local gradients for a given training iteration or neural network layer should have the same compression (so as to simplify the job of the parameter server), then when one training machine needs to change its level of compression, this machine can either send control messages to all of the other training machines or to the parameter server (for the parameter server to send control messages to the other training machines).

In addition, other metadata such as information from the training machines can be used to determine the level of compression used by the smart NIC for the local gradients. For example, some embodiments increase or decrease the level of compression as the training progresses (i.e., using more or less compression for the gradients sent during later iterations). In some embodiments, the earlier iterations push the parameters in a general direction (so the gradients can be more compressed), whereas later iterations refine the parameters by smaller amounts (so the gradients need to retain more detailed information).

While this compression is lossy, in many cases the effect on the ML training is minimal, as described in “Drive: One-bit Distributed Mean Estimation” by Vargaftik, et al., Advances in Neural Information Processing Systems 34 (2021) and “EDEN: Communication-Efficient and Robust Distributed Mean Estimation for Federated Learning” by Vargaftik, et al., arXivpreprint arXiv:2108.08842 (2021), both of which are incorporated herein by reference. If all of the distributed training machines independently generate local gradients and compress these gradients, the errors occurring as the result of the compression are independent. Therefore, as the number of training machines increases, these errors become more and more likely to cancel each other out. Given that the parameter server is typically calculating a mean of all of the local gradients for a given trainable parameter, the error of this mean decays as the number of training machines increases. In addition, so long as the errors are not massive, many ML training processes are adaptive to the introduction of these errors. For instance, neural networks are often trained using stochastic gradient descent. In this case, if a set of weight values are pushed in a slightly suboptimal direction during one training iteration due to the introduction of errors, then the next training iteration should nevertheless push these weight values in the correct direction toward a local optimum. In many cases, taking a roundabout path through the solution space will not even require additional training iterations. Even if a small number of additional training iterations are required on account of the losses introduced, the compression can still speed up the overall training process because of the time saved in sending the gradients (potentially billions of gradients over the course of several training iterations).

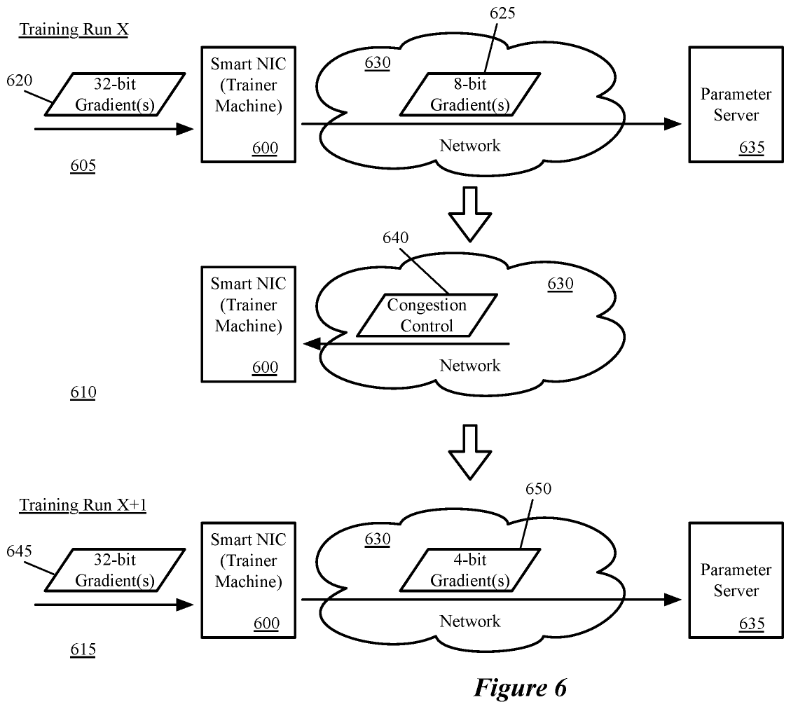

FIG. 6 conceptually illustrates the quantization of gradients by a smart NIC 600 based on network state for two different training runs, over three stages 605-615. In the first stage 605, during training iteration X, the local training machine (not shown in the figure) sends 32-bit local gradients 620 to the smart NIC 600. At this stage, the smart NIC 600 compresses the 32-bit local gradients 620 by a factor of 4 into 8-bit local gradients 625 and sends them via a network 630 to the parameter server 635.

In a second stage 610, either during or after training iteration X, the smart NIC 600 receives a congestion control message 640 specifying that the network has become over-congested. This message may be sent by the parameter server 635, the smart NIC located at the parameter server, or a network element located within the network 630. The congestion control message may be a TCP congestion control message in some embodiments or a different type of message used to indicate network congestion.

The third stage 615, during training iteration X+1, shows the result of this congestion control on subsequent gradient compression at the smart NIC 600. The local training machine again sends 32-bit local gradients 645 to the smart NIC 600, which compresses these local gradients down by a factor of 8 into 4-bit local gradients 650 and sends them via the network 630 to the parameter server 635. As a result, approximately half of the amount of data is sent for training iteration X+1 than was sent for training iteration X.

It should be noted that other types of compression besides quantization of the parameters may be used in some embodiments. These compression algorithms can include elimination of certain parameters that are smaller than a threshold value (sparsification) or projection of multi-dimensional parameters to a lower number of dimensions (e.g., using transformation, rotation, sketching, etc.). Some embodiments instead use compression techniques that rely on shared random numbers, which requires that the smart NIC at the computer and the smart NIC at the parameter server are given the same seed value.

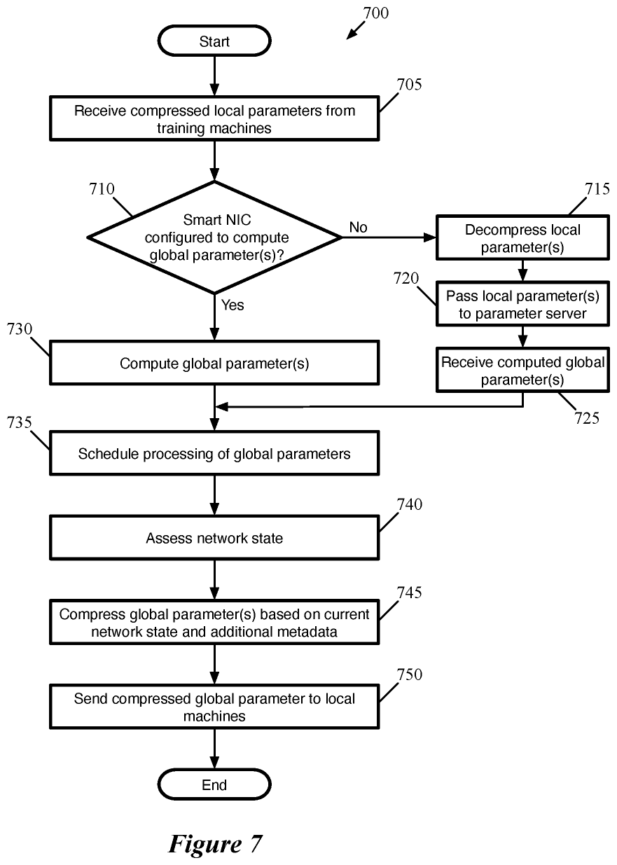

In addition to the smart NICs at the host computers on which the training machines execute dynamically assessing state and compressing the parameters, much of the operation of the parameter server is handled by a smart NIC in some embodiments. FIG. 7 conceptually illustrates a process 700 of some embodiments for handling sets of local parameters from a set of distributed training machines and providing global parameters to these training machines. In some embodiments, the process 700 is performed by a smart NIC located at a parameter server (i.e., serving as the network interface for the parameter server). Like the process 400 described above, it should be understood that the smart NIC at the parameter server performs this process (or a similar process) for each set of parameters for which it needs to compute global parameters (e.g., for the gradients of each neural network layer, at each training iteration).

As shown, the process 700 begins by receiving (at 705) compressed local parameters from the training machines of a distributed training system. In some embodiments, the training machines synchronize when they send corresponding sets of local parameters to the parameter server so that the parameter server receives all of the sets of local parameters for a given global parameter computation (e.g., all of the sets of local gradients for a particular neural network layer during a particular training iteration) at approximately the same time. In other embodiments, the smart NIC receives these local parameter sets as the respective training machines complete the necessary calculations and the respective smart NICs for those training machines compress and send the local parameter sets to the parameter server (as described above by reference to FIG. 1). Some embodiments, though not shown in the figure, will send a message (e.g., a control message) to a subset of the training machines and/or their smart NICs requesting a particular set of local parameters if the parameter server smart NIC has received the corresponding local parameters from a threshold number of the training machines and is waiting on one training machine or a small subset of them as bottlenecks for the particular set of parameters.

When all of the local parameters have been received for a particular parameter set, the process 700 then determines (at 710) whether the smart NIC is configured to compute the global parameters itself. In some embodiments, the smart NIC at the parameter server may only perform compression/decompression for at least a subset of the parameter sets, with software that executes on the host computer (either directly on the host computer operating system or in a virtualized DCN operating on the host computer) performing the global parameter calculations.

If the smart NIC is not configured to compute the global parameters, the process 700 decompresses (at 715) the local parameters and passes (at 720) the decompressed local parameters to the parameter server (e.g., through a PCIe interface). It should be noted that decompression does not typically restore all of the data that was lost through compression. In addition, in some embodiments, the decompression for some sets of local parameters is different than decompression for other sets of local parameters owing to the different levels of compression used. Unless there is synchronization between the smart NICs at the different training machines, a first set of local gradients for a particular neural network layer from a first training machine may be compressed differently than a second set of local gradients for the particular neural network layer from a second training machine.

The parameter server receives these decompressed local parameter sets from the smart NIC and computes a global parameter set. In some embodiments, the parameter server averages each local parameter (e.g., for each neural network weight and other trainable parameter, the parameter server averages all of the gradients computed by different training machines for the weight). As a result, because the errors introduced by compression are independent, these errors can be assumed to mostly cancel each out in the mean calculation so long as the number of training machines is sufficiently large. After the parameter server has performed these calculations, the process 700 receives (at 725) the computed global parameters from the parameter server.

On the other hand, if the smart NIC does not need to hand to the host computer for the computation, the smart NIC acts as the parameter server as the process 700 computes (at 730) the global parameters. As with the parameter server, this computation is often the computation of a mean value for each individual local parameter (e.g., for each neural network weight or other trainable parameter, an average of the local gradients is computed).

In some embodiments, the smart NIC decompresses the local parameters prior to computing the global parameters, using the decompressed local parameters for the computation. In other embodiments, when possible, the smart NIC performs at least part of the global parameter computation on the compressed values. For instance, the smart NIC of some embodiments is able to perform the global parameter computation on the compressed values if all of the local parameters are quantized to the same scale. This does not necessarily require that all of the smart NICs at the training machines quantize the local parameter sets using the same number of bits, but rather that the compressed values are all in the same range. For instance, if all of the training machine smart NICs compress the local gradients for a particular neural network layer to 2 bits, but those 2 bits represent a range from 0-31 for one training machine and a range from 0-7 for another training machine, the compressed values cannot be added without decompression. On the other hand, if the smart NICs at all of the training machines compress the local gradients to 4 bits representing a range from 0-31, then these values can be added without any decompression. In some embodiments, the training machine smart NICs synchronize their compression scales, either via control messages with each other or control messages from the smart NIC at the parameter server that coordinates the compression.

In some embodiments, the smart NIC computes the means for each parameter set by adding the compressed local parameters and then decompressing the sum before dividing by the number of local parameter sets (i.e., the number of training machines). This saves a substantial amount of processing by (i) only decompressing one value for each parameter (as opposed to decompressing one value per training machine for each parameter) and (ii) simplifying the addition of these values (e.g., adding a number of 2-bit values rather than 32-bit values). On the other hand, in some cases the smart NIC decompresses all of the parameter values and then computes the global parameter. This may be either because the parameters are compressed using different scales or because the smart NIC is not configured to use the compressed parameters.

Returning to FIG. 7, once the global parameters are computed (either by the smart NIC or the parameter server software on the computer), the process 700 schedules (at 735) the processing of the global parameters. As with the smart NICs at the training machine, if the load is not too high, in some embodiments the smart NIC at the parameter server processes each set of global parameters in the order they are computed.

However, some embodiments also allow for various types of dynamic scheduling. As with the local gradients at the training machine smart NICs, in some embodiments the smart NIC receives the global gradients for the parameters of a single neural network layer as a set to be sent out. Bottlenecks can also occur at the parameter server smart NIC if compression and sending of a layer of global gradients takes longer than computation of the global gradients and/or if the local gradients for multiple layers from one training machine are delayed but then arrive in a burst. In some embodiments, the parameter server smart NIC schedules the processing (which can, in some cases, include the computation) of the global gradients using similar criteria as the training machine smart NIC use for the local gradients. For instance, if global gradients for multiple neural network layers are complete and queued, some embodiments always process/send the gradients for the earliest available layer first.

In addition, if the distributed training system trains multiple ML models simultaneously, the parameter server smart NIC may also need to schedule sending global parameter sets for multiple models. In some embodiments, the parameter server smart NIC is preconfigured to give priority to specific models or specific layers of a model. In other embodiments, the smart NIC is configured to dynamically schedule sending the global parameters of the various different models based on various factors. For instance, different embodiments may give preference to parameters for a particular model or particular layers, alternate between models, or allow the training machines for models to send a notification to the parameter server when they are waiting for specific global gradients so that these global gradients can be moved up in the queue.

Next, the process 700 assesses (at 740) the network state. In some embodiments, the network state is assessed by the smart NIC for each set of global parameters that are compressed and sent as a group (e.g., the global gradients for each neural network layer). In other embodiments, the smart NIC assesses the network state once for a given training iteration and makes processing (e.g., parameter compression) decisions based on that state. The network state assessment, in different embodiments, may account for congestion of the network as a whole or specifically the connection to each training machine separately. In some embodiments, the smart NIC keeps statistics on the amount of data sent and received and uses these statistics to determine whether the network is overloaded. Alternatively, or additionally, in some embodiments the smart NIC uses congestion control messages from the training machines to determine the network state.

Next, the process 700 compresses (at 745) the local parameters based on the current network state and, in some cases, additional data. The process 700 then sends (at 750) the compressed global parameters to the parameter server, then ends. In general, as the network connection to the training machines (or the network generally) becomes more congested, the smart NIC increases the level of compression applied to the global parameters. That is, as network congestion increases, the smart NIC compresses a given amount of global parameter data into a smaller amount of compressed data to send to the parameter server. Because the smart NIC is closer to the network than the software networking components (or other components that could perform compression) of the computer running the parameter server, the smart NIC is in a better position to make these decisions about the level of compression and can implement the changes more quickly.

Whereas the smart NICs at the various training machines can use different levels of compression for corresponding sets of local parameters (e.g., a first smart NIC quantizing a set of local parameters to 4 bits per parameter and a second smart NIC quantizing its corresponding set of local parameters to 2 bits per parameter), in some embodiments the global parameters are compressed only once, and those compressed parameters are sent to all of the training machines. It is inefficient to compress the global parameters to multiple different levels even if the network connection state to two different training machines is different. Furthermore, because the compression is lossy, if differing compression was used, different training machines would end up with different global parameters and thus the ML models at those different training machines would diverge. Some embodiments, therefore, identify the connection to one of the training machines with the most congestion and choose the level of compression based on that network state. Other embodiments use a holistic network state assessment and choose the level of compression based on that holistic assessment. As with the local parameters, some embodiments increase or decrease the level of compression as the training progresses (i.e., using more or less compression for the parameters sent during later iterations) or use other factors to determine the level of compression. In addition, as noted, some embodiments do not compress the global parameters before sending them to the training machines.

As with the compression of local parameters, the type of compression used by the parameter server smart NIC can vary in different embodiments. For instance, some embodiments quantize the parameters to different numbers of bits depending on the network connection assessment. A 32-bit parameter, for example, could be quantized to 8 bits if the network connection is not congested but quantized to 4 bits (or even less) if the network connection is more congested. Some embodiments are able to compress gradients down to less than one bit per gradient value. It should be noted that other types of compression besides quantization of the parameters may be used in some embodiments. These compression algorithms can include elimination of certain parameters that are smaller than a threshold value (sparsification) or projection of multi-dimensional parameters to a lower number of dimensions (e.g., using transformation, rotation, sketching, etc.). Some embodiments instead use compression techniques that rely on shared random numbers, which requires that the smart NIC at the parameter server and the smart NICs at the training machines are given the same seed value.

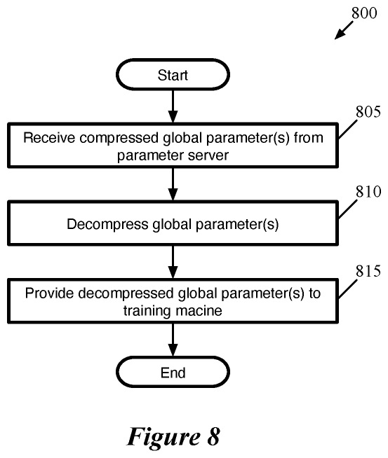

After the parameter server (e.g., the smart NIC at the parameter server) sends out the compressed global parameters to the training machines, the smart NICs at the host computers for each of the training machines receive the compressed global parameters from the parameter server. FIG. 8 conceptually illustrates a process 800 of some embodiments for providing these global parameters to a training machine. The process 800 is performed by a smart NIC of a host computer on which a training machine executes. In some embodiments, this process (or a similar process) is performed, for each set of global parameters sent by the parameter server, by each of the smart NICs at a host computer on which at least one training machine operates.

As shown, the process 800 begins by receiving (at 805) a compressed set of global parameters from the parameter server. As described above, in some embodiments each set of global parameters indicates the gradients for updating the trainable parameters of a neural network layer. The process 800 then decompresses (at 810) the received global parameters. Whereas compression of local parameters involves various scheduling and compression level determination operations, some embodiments decompress the global parameter sets as these global parameters are received. The process 800 then provides (at 815) the decompressed global parameters to the training machine, which allows the training machine to update its copy of the ML model and begin (or continue) its next training iteration.

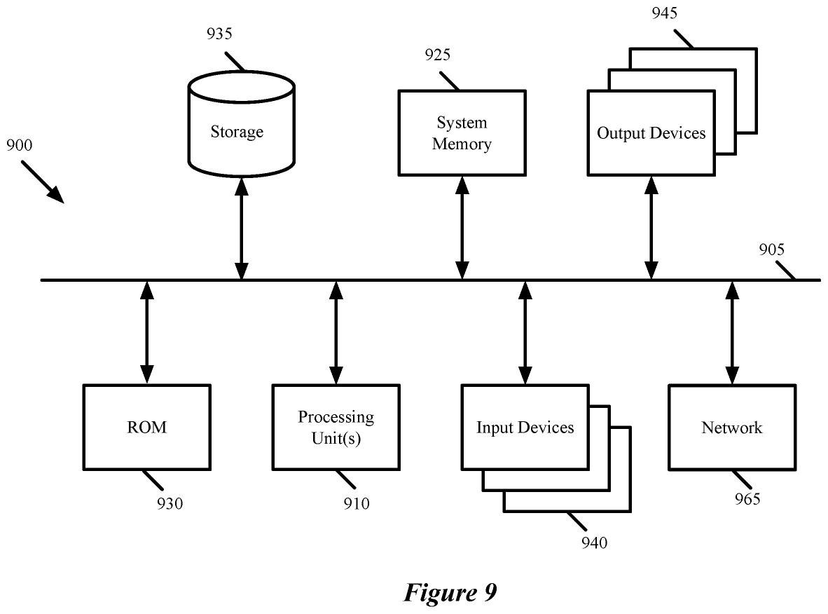

FIG. 9 conceptually illustrates an electronic system 900 with which some embodiments of the invention are implemented. The electronic system 900 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 900 includes a bus 905, processing unit(s) 910, a system memory 925, a read-only memory 930, a permanent storage device 935, input devices 940, and output devices 945.

The bus 905 collectively represents all system, peripheral, and chipset buses that communicatively connect the numerous internal devices of the electronic system 900. For instance, the bus 905 communicatively connects the processing unit(s) 910 with the read-only memory 930, the system memory 925, and the permanent storage device 935.

From these various memory units, the processing unit(s) 910 retrieve instructions to execute and data to process in order to execute the processes of the invention. The processing unit(s) may be a single processor or a multi-core processor in different embodiments.

The read-only-memory (ROM) 930 stores static data and instructions that are needed by the processing unit(s) 910 and other modules of the electronic system. The permanent storage device 935, on the other hand, is a read-and-write memory device. This device is a non-volatile memory unit that stores instructions and data even when the electronic system 900 is off. Some embodiments of the invention use a mass-storage device (such as a magnetic or optical disk and its corresponding disk drive) as the permanent storage device 935.

Other embodiments use a removable storage device (such as a floppy disk, flash drive, etc.) as the permanent storage device. Like the permanent storage device 935, the system memory 925 is a read-and-write memory device. However, unlike storage device 935, the system memory is a volatile read-and-write memory, such a random-access memory. The system memory stores some of the instructions and data that the processor needs at runtime. In some embodiments, the invention's processes are stored in the system memory 925, the permanent storage device 935, and/or the read-only memory 930. From these various memory units, the processing unit(s) 910 retrieve instructions to execute and data to process in order to execute the processes of some embodiments.

The bus 905 also connects to the input and output devices 940 and 945. The input devices enable the user to communicate information and select commands to the electronic system. The input devices 940 include alphanumeric keyboards and pointing devices (also called “cursor control devices”). The output devices 945 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 9, bus 905 also couples electronic system 900 to a network 965 through a network adapter (not shown). In this manner, the computer can be a part of a network of computers (such as a local area network (“LAN”), a wide area network (“WAN”), or an Intranet, or a network of networks, such as the Internet. Any or all components of electronic system 900 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIGS. 4, 7, and 8) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method for performing distributed machine learning (ML) across a plurality of computers, the method comprising:
at a smart network interface controller (NIC) of a first computer:
receiving a set of ML parameters from the first computer related to training an ML model;
compressing the set of ML parameters based on a current state of a connection to a central computer that receives sets of ML parameters from a plurality of the computers; and
sending the compressed set of ML parameters to the central computer for the central computer to process the compressed set of ML parameters along with corresponding sets of ML parameters received from the other computers of the plurality of computers.

2. The method of claim 1, wherein:
the set of ML parameters is a set of local gradients computed for the ML model at the first computer; and
the central computer receives corresponding sets of local gradients computed for the ML model from each of the computers of the plurality of computers.

3. The method of claim 2, wherein:
each local gradient in the set of local gradients specifies an update to a different trainable parameter of the ML model based on local training of the ML model at the first computer; and
each of the respective other computers of the plurality of computers computes respective sets of local gradients specifying updates to the trainable parameters based on respective local training of the ML model at the respective other computer.

4. The method of claim 3, wherein:
the ML model is a neural network; and
the set of local gradients comprises gradients for updating the trainable parameters of a particular layer of the neural network.

5. The method of claim 4, wherein the set of local gradients is a first set of local gradients, the particular layer is a first layer of the neural network, and the current state of the connection is a first state, the method further comprising, at the smart NIC:
receiving a second set of local gradients from the first computer for updating trainable parameters of a second layer of the neural network;
compressing the second set of local gradients based on a second state of the connection to the central computer; and
sending the compressed second set of local gradients to the central computer for the central computer to process the compressed second set of local gradients along with corresponding sets of local gradients received from the other computers of the plurality of computers.

6. The method of claim 4, wherein the set of local gradients is a first set of local gradients, the particular layer is a first layer of a first neural network, and the current state of the connection is a first state, the method further comprising, at the smart NIC:
receiving a second set of local gradients from the first computer for updating trainable parameters of a second layer of a second neural network;
compressing the second set of local gradients based on a second state of the connection to the central computer; and
sending the compressed second set of local gradients to the central computer for the central computer to process the compressed second set of local gradients along with corresponding sets of local gradients received from the other computers of the plurality of computers.

7. The method of claim 1, wherein the smart NIC is a first smart NIC, wherein a second smart NIC of the central computer processes the compressed set of ML parameters along with the corresponding sets of ML parameters from the other computers.

8. The method of claim 7, wherein the second smart NIC computes a set of global parameters based on the received corresponding sets of compressed parameters and provides the global parameter set to the plurality of computers.

9. The method of claim 8, wherein each global parameter in the global parameter set is an average of corresponding parameters received from the plurality of computers.

10. The method of claim 9, wherein the second smart NIC performs at least a portion of the computation of the averages without decompressing the sets of ML parameters received from the plurality of computers.

11. The method of claim 8, wherein the global parameters are used by each respective computer of the plurality of computers to update a respective copy of the ML model at the respective computer.

12. The method of claim 8, wherein the second smart NIC decompresses the compressed ML parameters received from the plurality of computers and compresses the global parameters prior to providing the global parameters to the plurality of computers.

13. The method of claim 1 further comprising, after sending the compressed parameter to the central computer:
receiving a compressed set of global parameters from the central computer based on the central computer processing the sets of ML parameters received from the plurality of computers;
decompressing the compressed set of global parameters; and
providing the decompressed set of global parameters to the first computer for training the ML model.

14. The method of claim 1, wherein compressing the set of ML parameters comprises quantizing each parameter to a specific number of bits.

15. The method of claim 14, wherein the specific number of bits varies based on the current state of the connection to the central computer.

16. The method of claim 1 further comprising evaluating the current state of the connection to the central computer to determine a level of compression.

17. The method of claim 11, wherein evaluating the current state of the connection comprises:
receiving a congestion control message at the first smart NIC; and
modifying the level of compression for subsequent sets of ML parameter based on the received congestion control message.

18. A non-transitory machine-readable medium storing a program which when executed by at least one processing unit of a smart network interface controller (NIC) of a first computer enables distributed machine learning (ML) across a plurality of computers, including the first computer, the program comprising sets of instructions for:
receiving a set of ML parameters from the first computer related to training an ML model;
compressing the set of ML parameters based on a current state of a connection to a central computer that receives sets of ML parameters from a plurality of the computers; and
sending the compressed set of ML parameters to the central computer for the central computer to process the compressed set of ML parameters along with corresponding sets of ML parameters received from the other computers of the plurality of computers.

19. The non-transitory machine-readable medium of claim 18, wherein:
the set of ML parameters is a set of local gradients computed for the ML model at the first computer, each local gradient in the set of local gradients specifying an update to a different trainable parameter of the ML model based on local training of the ML model at the first computer;
the central computer receives corresponding sets of local gradients computed for the ML model from each of the computers of the plurality of computers, each of the respective other computers of the plurality of computers computing respective sets of local gradients specifying updates to the trainable parameters based on respective local training of the ML model at the respective other computer.

20. The non-transitory machine-readable medium of claim 19, wherein:
the ML model is a neural network;
the set of local gradients is a first set of local gradients for updating the trainable parameters of a first layer of the neural network;
the current state of the connection is a first state; and
the program further comprises sets of instructions for:
receiving a second set of local gradients from the first computer for updating trainable parameters of a second layer of the neural network;
compressing the second set of local gradients based on a second state of the connection to the central computer; and
sending the compressed second set of local gradients to the central computer for the central computer to process the compressed second set of local gradients along with corresponding sets of local gradients received from the other computers of the plurality of computers.

21. The non-transitory machine-readable medium of claim 19, wherein:
the ML model is a first neural network;
the set of local gradients is a first set of local gradients for updating the trainable parameters of a first layer of the first neural network;
the current state of the connection is a first state; and
the program further comprises sets of instructions for:
receiving a second set of local gradients from the first computer for updating trainable parameters of a second layer of a second neural network;
compressing the second set of local gradients based on a second state of the connection to the central computer; and
sending the compressed second set of local gradients to the central computer for the central computer to process the compressed second set of local gradients along with corresponding sets of local gradients received from the other computers of the plurality of computers.

22. The non-transitory machine-readable medium of claim 18, wherein:
the smart NIC is a first smart NIC;
a second smart NIC of the central computer processes the compressed set of ML parameters along with the corresponding sets of ML parameters from the other computers, said processing comprising computing a set of global parameters based on the received corresponding sets of compressed parameters and providing the global parameter set to the plurality of computers.

23. The non-transitory machine-readable medium of claim 22, wherein:
each global parameter in the global parameter set is an average of corresponding parameters received from the plurality of computers;
the second smart NIC performs at least a portion of the computation of the averages without decompressing the sets of ML parameters received from the plurality of computers; and
the global parameters are used by each respective computer of the plurality of computers to update a respective copy of the ML model at the respective computer.

24. The non-transitory machine-readable medium of claim 18, wherein:
the set of instructions for compressing the set of ML parameters comprises a set of instructions for quantizing each parameter to a specific number of bits; and
the specific number of bits varies based on the current state of the connection to the central computer.

25. The non-transitory machine-readable medium of claim 18, wherein the program further comprises a set of instructions for evaluating the current state of the connection to the central computer to determine a level of compression.
